(19) United States
(12) Patent Application Publication
(10) Pub. No.: US 2006/0257630 A1
(43) Pub. Date: Nov. 16, 2006

(54) Method and device for wetting a substrate with a liquid

(76) Inventors: Gerhard Hartwich, Munchen (DE); Peter Frischmann, Munchen (DE); Herbert Wieder, Munchen (DE); Thomas Kratzmuller, Munchen (DE); Nobert Persike, Munchen (DE)

Correspondence Address: Marc J Frechette;Crockett & Crockett, Suite 400, 24012 Calle de la Plata, Laguna Hills, CA, 92653, US

(21) Appl. No.: 10/550,475

(22) PCT Filed: Mar. 22, 2004
(86) PCT No.: PCT/EP04/02977

§ 371 Date: Jul. 10, 2006

(30) Foreign Application Priority Data
Mar. 21, 2003 (DE) 103 12 628.7

(51) Int. Cl. B32B 9/00; B08B 7/00; B08B 3/00; B05D 3/12; B05D 1/30; B05D 1/32

(52) U.S. Cl. 428/195.1; 428/457; 428/702; 428/426; 134/34; 134/33; 427/282; 427/421.1; 427/240; 427/420; 427/532

(57) ABSTRACT

A method for wetting a substrate with a fluid and a substrate is disclosed. The method includes the steps of providing a substrate, providing a wetting fluid, applying a protective layer to the substrate, patterning the protective layer and applying the wetting fluid to exposed wetting areas on the subtrate without direct contact between a wetting apparatus and the substrate surface.

This application claims priority of German patent application DE 103 12 628.7 filed Mar. 21, 2003.

### FIELD OF THE INVENTION

The present invention relates to a method and an apparatus for wetting a substrate with a fluid, as well as a fluid-wetted substrate obtainable by the method according to the present invention.

### BACKGROUND OF THE INVENTION

The wetting of a substrate with a fluid has broad applications in industry and science. Especially in the field of micropatterning of surfaces for the biosciences, medical devices and sensorics, both traditional lithographic methods and wetting methods have become increasingly important in recent years.

These wetting methods for lateral patterning of surfaces can be roughly grouped into two categories: methods with direct contact of the wetting apparatus with the substrate, and methods without direct contact.

In the patterning methods with direct contact, particular emphasis goes to microcontact printing (μCP), which was first introduced by Whitesides 1994 (A. Kumar, G. M. Whitesides, Science, 1994, 263, 60; U.S. Pat. No. 6,048,623). In this method, a micropatterned stamp is wetted with a fluid, thereafter brought into contact with the substrate to be processed, and in this way, a lateral chemical pattern is stamped on the surface. A great difficulty with this technique is the realization of a uniform contact between the stamp and the substrate, which is decisive for success/quality.

In addition to these patterned stamps, there are in the background art various apparatuses for placing fluid droplets on a substrate, such as needles, capillaries, rings and tweezers, which arose primarily as modifications of printing ink on paper. Here, the apparatus is dipped in the fluid to be transferred, so that material is transferred. This material is placed on the substrate with the apparatus and forms a wetted area that depends on the surface energies of the apparatus, the fluid and the substrate. In these methods, the transferred volume depends primarily on the diameter of the tip of the apparatus. Problems with these printing methods are variations in the transferred fluid volume and the need to bring the tip into physical contact with the substrate for the transfer, which can damage the surface of the substrate.

The inkjet printing methods are mentioned here by way of example of methods for transferring fluids to a substrate that make do without direct contact between the equipment and the substrate. With these techniques, the fluid is taken up in the print head and the latter positioned above the desired substrate location. A force is exerted on the fluid by a piezoelectric crystal or a pump, so that a droplet leaves the contact head and is transferred to the substrate.

In the contactless methods, too, the size of the wetted region is determined by the surface energies of the materials involved. The droplet's equilibrium state, defined by the contact angle between the fluid and the substrate, is highly dependent on such factors as surface roughness, chemical inhomogeneities of the material, variations in the surrounding atmosphere and, of course, impurities. Thus, in a real system, the transferred droplets will wet very differently on a macroscopic substrate. The methods of the background art are thus fundamentally limited in terms of tolerances in spot sizes and wetting volumes.

### DESCRIPTION OF THE INVENTION

Therefore, it is the object of the present invention to provide a method and an apparatus for wetting substrates with a fluid that do not exhibit the disadvantages of the background art.

According to the present invention, this object is solved by the method according to claim 1, the apparatus according to claim 38 and the fluid-wetted substrate according to claim 40. Further advantageous details, aspects and embodiments of the present invention are evident from the dependent claims, the description, the drawings and the examples.

The following abbreviations and terms will be used in the context of the present invention:

General

μCP micro-contact printing
AFM atomic force microscope
analyte fluid A fluid potentially containing an analyte that is to be detected using a sensor.
fluid Not just pure liquid substances, but also fluids with detergent, any kind of dissolved organic or inorganic substances, as well as emulsions, suspensions and colloidal solutions.
laser ablation Partial or complete removal of organic or inorganic protective layers, as well as the removal of impurities on a substrate by irradiation with laser light.
solder resist Paint known from printed circuit board technology, applied to boards to prevent the formation of solder bridges in automated soldering.
pseudo-contact printing The application of a fluid with the aid of a needle, capillary, tweezer, ring or stamp. An arrangement of needles, capillaries, tweezers, rings or stamps on a patterned substrate, wherein no direct contact occurs between the wetting apparatus and the substrate due to the protective layer and the lateral dimension of the tips of the wetting apparatus, which are preferably larger than the exposed surfaces to be wetted.
protective layer A layer applied to the substrate to be processed, prior to the actual wetting. For this, any material can be used that forms a complete layer on the substrate surface and thus separates said surface from the surroundings and can later be removed partially and without residue by laser ablation. This protective layer can consist of organic or inorganic materials and, depending on the substrate type and application requirements, can be physisorbed, chemisorbed or covalently bound and applied with any techniques.
SEM scanning electron microscopy
substrate A solid with a freely accessible surface that therefore can be wetted with a fluid. Plastics as well as metals, semiconductors, glasses, composites and porous materials can be used as the solid substrate. The term “surface” is independent of the spatial dimensions of the surface and also includes nanoparticles (particles or clusters comprising a few individual to several hundred thousand surface atoms or molecules).
UV ultraviolet light
   Genetics
DNA deoxyribonucleic acid
RNA ribonucleic acid
PNA peptide nucleic acid (Synthetic DNA or RNA in which the sugar-phosphate moiety is replaced by an amino acid. If the sugar-phosphate moiety is replaced by the —NH—(CH₂)₂—N(COCH₂-base)-CH₂CO— moiety, PNA will hybridize with DNA.)
A adenine
G guanine
C cytosine
T thymine
base A, G, T, or C
bp base pair
nucleic acid At least two covalently linked nucleotides or at least two covalently linked pyrimidine (e.g. cytosine, thymine or uracil) or purine bases (e.g. adenine or guanine). The term nucleic acid refers to any “backbone” of the covalently linked pyrimidine or purine bases, such as the sugar-phosphate backbone of DNA, cDNA or RNA, a peptide backbone of PNA, or analogous structures (e.g. a phosphoramide, thiophosphate or dithiophosphate backbone). An essential feature of a nucleic acid within the meaning of the present invention is that it can sequence-specifically bind naturally occurring cDNA or RNA.
nucleic acid oligomer A nucleic acid of a base length that is not further specified (e.g. nucleic acid octamer: a nucleic acid having any backbone in which 8 pyrimidine or purine bases are covalently bound to one another).
oligomer equivalent to nucleic acid oligomer
oligonucleotide Equivalent to oligomer or nucleic acid oligomer, so for example a DNA, PNA or RNA fragment of a base length that is not further specified.
oligo abbreviation for oligonucleotide
ss single-strand
   Chemicals
alkyl The term “alkyl” refers to a saturated hydrocarbon radical that is straight chain or branched (e.g. ethyl, isopropyl, or 2,5-dimethylhexyl, etc.). When “alkyl” is used to indicate a linker or spacer, the term refers to a group having two available valences for covalent linkage (e.g. —CH₂CH₂—, —CH₂CH₂CH₂—, or —CH₂C(CH₃)₂CH₂CH₂C(CH₃)₂CH₂—, etc.).
alkenyl Alkyl groups in which one or more of the C—C single bonds are replaced by C═C double bonds.
alkynyl Alkyl or alkenyl groups in which one or more of the C—C single or C═C double bonds are replaced by C≡C triple bonds.
heteroalkyl Alkyl groups in which one or more of the C—H bonds or C—C single bonds are replaced by C—N, C═N, C—P, C═P, C—O, C═O, C—S, or C═S bonds.
heteroalkenyl Alkenyl groups in which one or more C—H bonds, C—C single or C═C double bonds are replaced by C—N, C═N, C—P, C═P, C—O, C═O, C—S, or C═S bonds.
heteroalkynyl Alkynyl groups in which one or more of the C—H bonds, C—C single, C═C double or C═C triple bonds are replaced by C—N, C═N, C—P, C═P, C—O, C═O, C—S, or C═S bonds.
C18 octadecanethiol
fluorophore A chemical compound (chemical substance) that is capable of giving up, upon excitation with light, a longer-wave (red-shifted) fluorescent light. Fluorophores (fluorescent dyes) can absorb light in a wavelength range from the ultraviolet (UV) to the visible (VIS) to the infrared (1R) range. The absorption and emission maxima are typically shifted against each other by 15 to 40 nm (Stokes shift).
ligand Refers to molecules that are specifically bound by ligates; examples of ligands within the meaning of the present invention are substrates, cofactors and coenzymes of a protein (of an enzyme), antibodies (as the ligand of an antigen), antigens (as the ligand of an antibody), receptors (as the ligand of a hormone), hormones (as the ligand of a receptor) and nucleic acid oligomers (as the ligand of the complementary nucleic acid oligomer).
ligate Refers to a (macro-)molecule on which are located specific recognition and binding sites for the formation of a complex with a ligand (template).
fluorescein resorcinolphthalein
R As a substituent or side chain, any organic residue that is not further specified.
amines molecules having the general structure H₂N-spacer-R
silanes molecules having the general structure X₃—Si-spacer-R, wherein e.g. X═H, Cl, OCH₃
thiols molecules having the general structure HS-spacer-R or [S-spacer-R]₂
spacer Any molecular link between two molecules or between a surface atom, surface molecule or a surface molecule group and another molecule, normally alkyl, alkenyl, alkynyl, heteroalkyl, heteroalkenyl, or heteroalkynyl chains. Preferred spacers are those having a chain length of 1-20, especially a chain length of 1-14, the chain length representing the shortest continuous link between the structures to be linked.
Au—S—(CH₂)₂-ss-oligo-fluorescein A gold surface having a covalently applied monolayer consisting of derivatized single-strand oligonucleotide. Here, the oligonucleotide's terminal phosphate group at the 3′-end is esterified with (HO—(CH₂)₂—S)₂ to form P—O—(CH₂)₂—S—S—(CH₂)₂—OH, the S—S bond being homolytically cleaved and producing one Au—S—R bond each. At the free end, the probe oligonucleotide bears a covalently attached fluorophore fluorescein.
oligo-spacer-S—S-spacer-oligo Two identical or different nucleic acid oligomers that are linked with each other via a disulfide bridge, the disulfide bridge being attached to the nucleic acid oligomers via any two spacers, and the two spacers being able to have differing chain lengths (the shortest continuous link between the disulfide bridge and the respective nucleic acid oligomer), especially any chain length between 1 and 14, and these spacers, in turn, being able to be bound to various reactive groups that are naturally present on the nucleic acid oligomer or that have been affixed thereto by modification.
(n×HS-spacer)-oligo A nucleic acid oligomer to which n thiol functions are each attached via a spacer, each spacer being able to exhibit a differing chain length (the shortest continuous link between the thiol function and the nucleic acid oligomer), especially any chain length between 1 and 14. These spacers, in turn, may be bound to various reactive groups that are naturally present on the nucleic acid oligomer or that have been affixed thereto by modification, and “n” is any integer, especially a number between 1 and 20.
(n×R—S—S-spacer)-oligo A nucleic acid oligomer to which n disulfide functions are each attached via a spacer, the disulfide function being saturated by any residue R. Each spacer for attaching the disulfide function to the nucleic acid oligomer can exhibit a different chain length (shortest continuous link between the disulfide function and the nucleic acid oligomer), especially any chain length between 1 and 14. These spacers, in turn, can be bound to various reactive groups that are naturally present on the nucleic acid oligomer or that have been affixed thereto by modification. The variable “n” is any integer, especially a number between 1 and 20.

According to the present invention, a method for wetting a substrate with a fluid comprises the following steps:
a) providing a substrate having a surface to be wetted;
b) providing a wetting fluid;
c) applying to the substrate a protective layer that separates the surface to be wetted from the surroundings;
d) patterning the protective layer to expose predetermined wetting areas on the substrate surface to be wetted; and
e) applying the wetting fluid to the exposed wetting areas by means of a wetting apparatus without direct contact between the wetting apparatus and the substrate surface to be wetted.

Through the approach according to the present invention, impurities in the wetting areas are largely precluded and wetting apparatus wear is minimized. At the same time, by patterning the protective layer, the substrate areas to be wetted can be easily defined. The geometric interplay between the size of the wetting apparatus, the lateral dimensions of the wetting areas and the thickness of the protective layer adjoining the wetting areas facilitates a well-defined release of the wetting fluid from the wetting apparatus to the surface of the substrate.

Here, advantageously, a solid consisting of plastic, metal, semiconductor, glass, composite, or porous material or consisting of a combination of these materials is provided as the substrate. In particular, preferably, a solid whose surface to be wetted is formed by a silicon, platinum or gold layer or an oxidic layer or a glass is provided as the substrate.

The spatial form of the substrate is not limited according to the present invention. Rather, for example, a macroscopic solid disk or a micro- or nanoparticle can be provided as the substrate.

In the context of the present invention, the term “wetting fluid” comprises especially purely liquid substances, solutions of organic and/or inorganic substances, emulsions, suspensions or colloidal solutions.

The material of the protective layer is expediently so coordinated with the substrate material that the protective layer material is physisorbed or chemisorbed on the substrate surface to be wetted, or bound to it covalently, coordinatively or through complex formation. For example, as the protective layer, a positive or negative photoresist can be applied to the substrate, preferably sprayed on or spun on. A solder resist can likewise be applied as the protective layer for the substrate. Here, it is preferred that the solder resist is applied by screen printing, curtain coating or a spray method.

According to a further method variation, an organic polymer, especially consisting of cellulose, dextran or collagen, is applied to the substrate as the protective layer. The organic polymer is preferably spun on or physisorbed.

According to yet another advantageous variation, as the protective layer is applied a self-assembled monolayer consisting of organic molecules. It is manufactured especially by dissolving the organic molecules in an aqueous or organic solvent and bringing the solution into contact with the substrate.

A particularly preferred embodiment results when, advantageously, as the substrate is provided a solid whose surface to be wetted is formed by a gold layer and when as the protective layer is applied a self-assembled monolayer consisting of thiols, especially having the general structure HS-spacer-R or [S-spacer-R]₂. Here, R represents any headgroup and the spacer has a chain length of 1-20, especially of 1-14.

Another particularly preferred embodiment results when as the substrate is provided a solid whose surface to be wetted is formed by a silicon or platinum layer, and when as the protective layer is applied a self-assembled monolayer consisting of amines, especially having the general structure H₂N-spacer-R. Here, too, R represents any headgroup and the spacer has a chain length of 1-20, especially of 1-14.

According to a further preferred embodiment, as the substrate is provided a solid whose surface to be wetted is formed by an oxidic surface or a glass.

Here, as the protective layer is applied a self-assembled monolayer consisting of silanes, especially having the general structure X₃—Si-spacer-R, wherein R is any headgroup and X═H, Cl or OCH₃ and the spacer has a chain length of 1-20, especially 1-14.

In all three method variations cited, the headgroup R is expediently selected from the group CH₃, OH, CO₂H, NH₂, NH₃⁺ or SO₃⁻.

In step c), advantageously, the protective layer is applied in the form of a complete layer to the substrate surface to be wetted. Here, it can either be applied to the entire surface of the substrate, or cover only sub-regions of the surface. In the region of the desired wetting, expediently, the protective layer is subsequently removed without residue.

In a preferred embodiment, the patterning of the protective layer occurs by means of laser ablation, especially by irradiation of sub-regions of the protective layer with continuous or pulsed laser radiation of a predetermined wavelength. For this, the protective layer is especially pulsed with the laser radiation directly, through a lens system or through a mask to expose the wetting areas.

It has proven to be advantageous when, due to the laser radiation, the substrate surface to be wetted is melted in the region of the wetting areas. This results in reduced surface roughness and improved homogeneity of the substrate surface. In addition, by the ablation of a few gold layers, impurities are removed from the surface.

The wetting areas are advantageously created with a characteristic dimension of about 5 μm to about 200 μm, preferably from about 10 μm to about 100 μm. A value of about 20 μm to about 500 μm, preferably from about 50 μm to about 200 μm is set as the lateral spacing. The wetting areas advantageously exhibit a substantially rectangular, elliptical or circular contour.

According to an advantageous aspect of the present invention, in step d), supply channels are additionally introduced into the protective layer to facilitate the supply of an analyte fluid to the exposed wetting areas.

Here, the supply channels are expediently introduced into the protective layer with a depth of 10% to 99%, preferably of 20% to 95%, particularly preferably of 50% to 95% of the thickness of the protective layer. Here, the exposed wetting areas are advantageously disposed within the supply channels.

In the method according to the present invention, the wetting apparatus especially comprises a single needle, capillary, tweezer, ring or stamp. In the context of the present invention, it can also be an arrangement of multiple needles, capillaries, tweezers, rings, stamps, or a various arrangement these elements.

According to an expedient embodiment, the wetting apparatus exhibits a fluid-dispensing end surface whose lateral dimension in at least one direction in space is larger than the lateral dimension of the wetting areas in that direction in space. In this way, when aligned correctly, direct contact between the wetting apparatus and the surface of the substrate can be avoided.

Advantageously, the end surface of the wetting apparatus exhibits in both directions in space a larger lateral dimension than the wetting areas, so that direct contact between the wetting apparatus and the wetting areas is avoided in all relative orientations.

For applying the wetting fluid, preferably, the end surface of the wetting apparatus is brought into contact with the protective layer adjoining the wetting area. In this way, a droplet of the wetting fluid can be introduced in a controlled manner into the patterned recess in the protective layer without direct contact with the substrate surface.

In particular, for the application of the wetting fluid, the end surface of the wetting apparatus can be brought into contact, across the entire wetting area and from above, with the surface of the protective layer adjoining the wetting area.

In an advantageous embodiment of the present invention, the end surface of the wetting apparatus is positionable with a precision (Δx, Δy) laterally above a patterned protective layer, and the wetting areas are created with a characteristic lateral dimension (xₛₚₒₜ, yₛₚₒₜ) that is smaller than the lateral dimension (xₜᵢₚ, yₜᵢₚ) of the end surface of the wetting apparatus by at least the positioning precision (Δx, Δy). In this way, it is ensured that the release of a droplet occurs in a controlled manner and only over the protective layer.

According to an expedient aspect of the present invention, modified nucleic acid oligomers in aqueous solution are applied as the wetting fluid. Here, the nucleic acid oligomers are modified with one or more reactive groups, at least one reactive group being designed for a direct reaction with the substrate surface to be wetted. Furthermore, the nucleic acid oligomers can be modified with a fluorophore for subsequent visualization.

The present invention also includes an apparatus for executing the described method. Particularly advantageously, such an apparatus includes a wetting apparatus whose end surface is positionable laterally above a patterned protective layer with a positioning precision of less than 50 μm, preferably of less than 10 μm.

The present invention further includes a fluid-wetted substrate obtainable by the method described above.

Further embodiments and advantages of the present invention are described in detail below:

As explained above, the present invention comprises a method for the controlled wetting of patterned substrates with a fluid by means of a wetting apparatus consisting of a single needle, capillary, tweezer, ring or stamp, or an arrangement of needles, capillaries, tweezers, rings or stamps. In the present invention, these wetting apparatuses can have tips having any lateral dimension, in other words, also, and even preferably, larger than the lateral area of the laser-ablated, free substrate locations. The wetting apparatus of the present invention makes do without direct contact with the substrate and can thus be called a pseudo-contact method.

Applying a Protective Layer to the Substrate

According to the present invention, the substrates are provided with a protective layer to bridge the critical period between the manufacturing of the substrate and the wetting of its surface. During this period, the protective layer prevents the adsorption of undesired impurities on the substrate surface.

For the protective layer, any material can be used that forms a complete layer on a surface and thus separates the substrate surface from the surroundings and can later be removed without residue at desired locations, for example by laser ablation. It is understood that, advantageously, for a given substrate, a matched protective layer is selected that is optimized in terms of the adhesion between the substrate and the protective layer. Likewise, the protective layer can be optimized with a view to the fluid to be used. In the case of aqueous solutions, a hydrophilic layer material is appropriate, so that the fluids wet the supply channels of the present invention and bubbles are avoided. In the case of oily fluids, on the other hand, hydrophobic material is to be preferred.

By adding detergents to the fluids used, improved wetting of the channel structures and thus good flow properties can be achieved independently of the layer material. In addition to the usual paints known in lithography (positive and negative photoresists) and printed circuit board technology (solder resists), organic polymers are also suitable, such as cellulose, dextran or collagen, or self-assembled monolayers consisting of organic molecules such as silanes or thiols. It is also conceivable to use paints whose special components form advantageous functionalizations for particular applications when the material dries on the surface.

The protective layer can be applied to the substrate for example by spraying in the case of the photoresists, by spin coating or physisorption in the case of the organic polymers, or by screen printing or curtain coating in the case of the solder resists.

In a preferred embodiment of the present invention, monolayers of organic molecules such as thiols or silanes having a variable chain length are applied to the substrate in a self-assembling process. For this, the organic molecules are dissolved in aqueous or organic solvents and the solution is brought into contact with the substrate to be coated. The deposition process ends in a monolayer of covalently bound molecules on the substrate.

In a particularly preferred embodiment of the present invention, thiols having for example the general structure HS-spacer-R or [S-spacer-R]₂ are applied to gold as a dense, ordered and passivating monolayer, wherein R can be any headgroup, such as R═CH₃, OH, CO₂H, NH₂, NH₃⁺ or SO₃⁻, and spacer is to be understood as a term for any molecular link between two molecules, normally alkyl, alkenyl, alkynyl, heteroalkyl, heteroalkenyl, heteroalkynyl chains having a chain length of 1-20, especially 1-14, the chain length being the shortest continuous link between the structures to be linked. Alternatively, the organic molecules can also be provided with amine groups (H₂N-spacer-R) instead of the thiol groups (SH-spacer-R), which can then be adsorbed on platinum or silicon surfaces by chemisorption or physisorption. If, alternatively, the thiol groups (SH-spacer-R) are replaced by silane groups (X₃—Si-spacer-R, wherein, for example, X═H, Cl, OCH₃), a covalently bound monolayer can be produced on oxidic surfaces or glasses.

In another preferred type of the present invention, protective layers comprising solder resists known from printed circuit board technology are applied to the substrates. Suitable are 2-component or 1-component solder resists that are applied by curtain coating methods, screen printing or spray methods and can subsequently cure in air or through UV irradiation. One advantage of this method variation is that the thickness of the solder resist layer can be freely set within a large range, e.g. in the curtain coating method by the speed of the substrate under the paint curtain.

Laser Ablation of the Protective Layer in Any Geometry

In the context of this application, the term “laser ablation” is understood to be not only the partial or complete removal of organic or inorganic protective layers, but also the removal of impurities on a substrate by irradiation with laser light. Advantageously, the laser ablation is employed to remove or pattern the applied protective layer in any geometry at desired locations of the substrate. In this way, it is possible to realize various, precisely defined free substrate areas or regions with a tapered protective layer in different sizes on one and the same substrate design merely by changing the laser lighting.

A further aspect of the solution according to the present invention is the melting of the substrate surface with complete removal of the protective layer by means of laser ablation, which can be achieved by setting the laser intensity or the exposure time to the properties of the substrate and the protective layer. In addition to reducing the surface roughness, this short-term, near-surface melting of the substrate surface closes existing pores in the material and thus improves the homogeneity of the free substrate surface. In addition, by the ablation of a few gold layers, impurities are removed from the surface.

The laser ablation can occur by direct irradiation of the light or by irradiation of the light through a lens system or a mask. Here, the size or the shape of the individual wetting areas to be exposed or patterned and their lateral spacing are arbitrary and depend only on the respective application. The wavelength of the laser light used, as well as the exposure time or the number and duration of the pulses depend on the combination of the protective layer and the material of the substrate surface, and are preferably optimized for each pair.

In a preferred variation of the present invention, with an excimer laser is burned, through a diaphragm, an arrangement of free wetting areas having a diameter of d=10-100 μm each and a lateral spacing of 50-200 μm in a monomolecular layer consisting of octadecanethiol.

In another preferred variation of the present invention, with an excimer laser are scribed in a solder resist, through multiple masks in multiple process steps, patterns comprising channels and free wetting areas that, in addition to the controlled wetting at the free substrate locations by means of the described pseudo-contact printing method, also facilitates the targeted contacting, with a fluid containing an analyte, of locations that are linked together via channels. In solder resist layers of 100-150 μm in thickness are cut with a certain number of laser pulses various channels of 80-100 μm in depth and 10-150 μm in width, and then within the channels, by additional laser pulses, the substrate is exposed at multiple locations having diameters of about d=10-100 μm. Such sensitive substrate locations exposed in the channel patterns considerably reduce the analyte fluid required for an analysis compared with the wetting of the entire substrate.

Wetting the Patterned Substrates with a Fluid in Pseudo-Contact Printing

According to the present invention, the wetting fluid is applied to the patterned substrate especially with the aid of a needle, capillary, tweezer, ring or stamp, or an arrangement of needles, capillaries, tweezers, rings or stamps. In the present application, the term “pseudo-contact printing” is used for the wetting process to distinguish the technique from known standard methods of “contact printing,” and to make it clear that, due to the existent protective layer and the lateral dimension of the tips of the wetting apparatus, which is preferably larger than the free areas to be wetted, no direct contact occurs between the wetting apparatus and the substrate surface. Since, additionally, the free substrate area to be wetted is limited by the protective layer of a predetermined height, the wetting apparatus encounters a geometric barrier of a defined dimension, so that a controlled wetting occurs.

In the context of the present invention, both purely liquid substances and any kind of dissolved organic or inorganic substances, as well as emulsions, suspensions and colloidal solutions can be used. Conceivable materials within the meaning of the present invention are dissolved coloring pigments or any functionalized polymers and nanoparticles. In the field of sensorics, with the present invention, all kinds of ligates can be applied to the substrate. The term ligates refers to molecules that specifically interact with a ligand to form a complex. Examples of ligates within the meaning of the present text are substrates, cofactors and coenzymes, as complex binding partners of a protein (enzyme), antibodies (as complex binding partners of an antigen), antigens (as complex binding partners of an antibody), receptors (as complex binding partners of a hormone), hormones (as complex binding partners of a receptor), nucleic acid oligomers (as complex binding partners of the complementary nucleic acid oligomer) and metal complexes.

In a preferred form of the present invention, the free substrate locations are wetted with modified nucleic acid oligomers in aqueous solution. The nucleic acid oligomer that is to be applied to the free surface is modified with one or more reactive groups via a covalently attached spacer of any composition and chain length, these reactive groups preferably being located near one end of the nucleic acid oligomer. The reactive groups are groups that can react directly with the unmodified surface. Examples of this are: (i) thiol-(HS-) or disulfide-(S—S-) derived nucleic acid oligomers having the general formula (n×HS-spacer)-oligo, (n×R—S—S-spacer)-oligo or oligo-spacer-S—S-spacer-oligo that react with a gold surface to form gold-sulfur bonds, (ii) amines that adsorb on platinum or silicon surfaces by chemisorption or physisorption and (iii) silanes that enter into a covalent bond with oxidic surfaces.

In pseudo-contact printing, the dispenser of the wetting apparatus having any lateral dimension (xₜᵢₚ, yₜᵢₚ) is positioned above the patterned protective film with a precision of (Δx, Δy) and, for wetting, is lowered so far that, upon release of the droplet, the contact of the wetting apparatus occurs only via the protective layer. This is ensured especially when the wetting areas exhibit a characteristic lateral dimension (xₛₚₒₜ, yₛₚₒₜ) that is smaller than the dimension of the dispenser by at least the positioning precision, in other words, the conditions
xₛₚₒₜ≦xₜᵢₚ−Δx and yₛₚₒₜ≦yₜᵢₚ−Δy
are met.

### BRIEF DESCRIPTION OF THE DRAWINGS

The invention will be explained in greater detail below by reference to exemplary embodiments in association with the drawings. Only the elements that are essential to understanding the present invention are depicted. Shown are:

FIG. 1 in (a) to (e), a schematic diagram of the process control for wetting a substrate with a fluid according to an embodiment of the present invention;

FIG. 2 in (a) and (b), SEM images of wetting locations exposed in a solder resist protective layer by laser ablation;

FIG. 3 in (a), an AFM image of a lasered and melted gold surface, and in (b), a cross-sectional height profile along the line B-B in FIG. 3(a); and

FIG. 4 the fluctuations in the fluorescence intensity at a plurality of identical measuring spots as a gauge of the surface-loading density with nucleic acid oligomers, (a) for nucleic acid oligomers spotted in a traditional manner and (b) for wetting of wetting areas on the substrate surface by by using a method according to the present invention.

### PREFERRED EMBODIMENTS

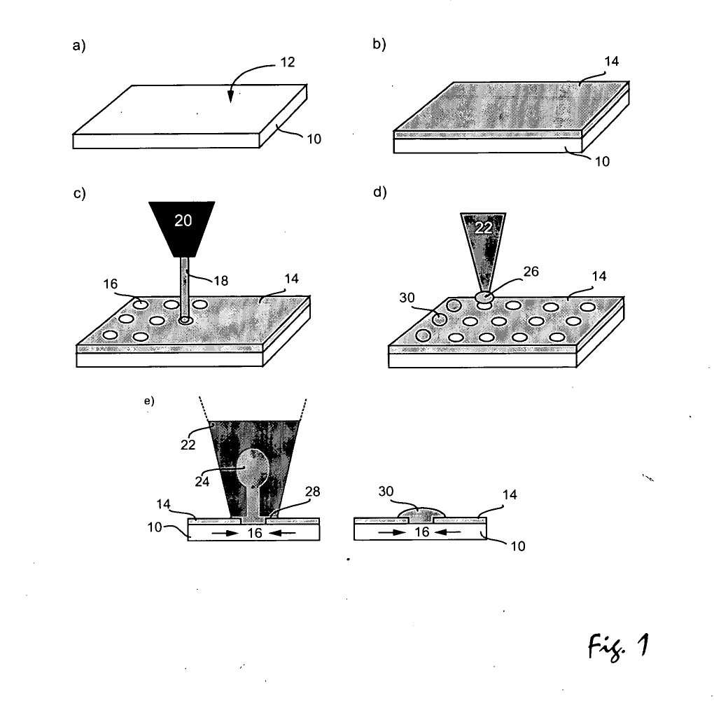

A method for wetting a substrate with a fluid according to an embodiment of the present invention is described below especially with reference to FIG. 1.

In a first step, a substrate 10 having a surface 12 to be wetted is provided, FIG. 1(a). In the embodiment, the substrate 10 consists of a glass slide having a vapor-deposited, 5-nm-thick CrNi contact layer and a gold layer, having a thickness of about 200 nm vapor deposited thereon.

Prior to loading with a protective layer, the substrate is treated with a standard piranha clean (t=30 s). For the application of a C18 protective layer 14 to the gold surface, the substrate 10 is incubated in ethanol for 5-12 hours at room temperature with 1 nmol/l octadecanethiol (C-18; Fluka) and, after incubation, rinsed with ethanol to remove unattached thiol, FIG. 1(b).

Thereafter, the C18 protective film 14 is patterned by laser ablation to form a plurality of wetting areas 16, as illustrated in FIG. 1(c). For example, the patterning of the C18 protective film is executed with beam 18 of a wavelength of 193 nm from an excimer laser 20 from Lambda Physik. The thiols of the protective layer 14 in the wetting areas 16 can be removed without residue with 3-pulses of 20 ns with a fluence of 100 mJ/cm².

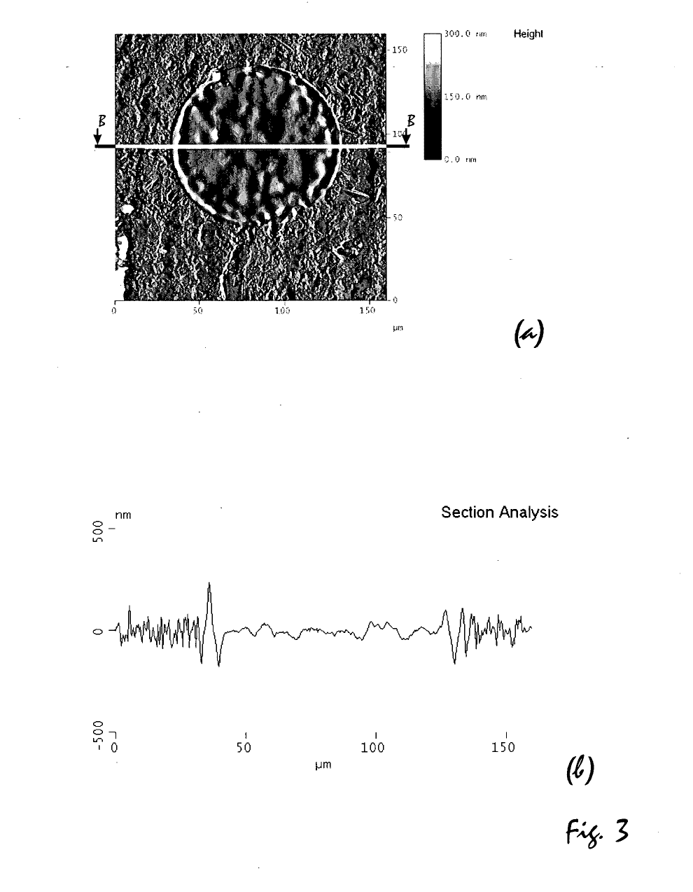

Furthermore, the laser bombardment of the substrate 10 leads to a melting of the gold surface, by which pores are closed, the roughness is reduced and impurities are removed (FIG. 3).

The laser radiation is imaged onto the substrate in reduced form, through a mask not shown, delivering in the exemplary embodiment an illumination spot having a diameter of 40-100 μm. The wetting areas are burned into the protective layer with a lateral spacing of, for example, 200 μm.

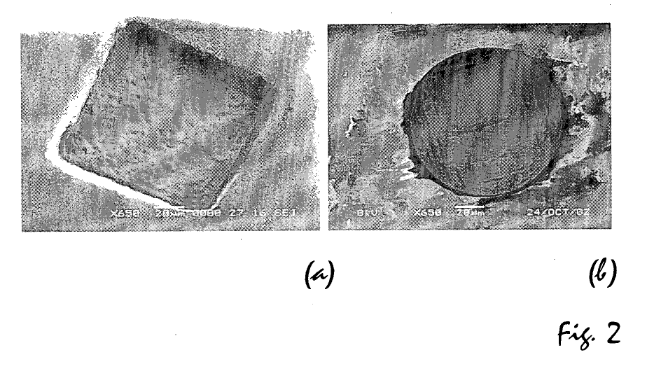

FIG. 2 shows SEM images of wetting areas 16 exposed in a protective layer 14 by laser ablation. For these SEM images, a solder resist protective layer was used instead of the C18 protective layer in FIG. 1. For this purpose, a 2-component solder resist (Elpemer GL 2467 μM-DG, from the Peters company) is applied to the substrate in a curtain coating method known from printed circuit board technology, to form a protective layer for the surface of the substrate. By varying the transportation speed of the substrate 10 under the paint curtain, any protective layer thickness in the range from about 10-150 μm can be achieved.

After the drying of the paint, the protective layer is patterned by laser ablation with an excimer laser from Lambda Physik. In the case of protective layers having a thickness of 15-20 μm, 90-150 pulses of 20 ns at a fluence of 600-1200 mJ/cm² remove the paint without residue and ensure surface-near melting of the gold substrates, closing existing pores, reducing roughness and eliminating surface impurities. The laser can be imaged onto the substrate in reduced form through various masks, the surface intensity of the radiation being set via the imaging apparatus. In this way, depending on the mask, various geometries of the ablated regions can be realized.

FIG. 2 illustrates that both rectangular/square cross sections (FIG. 2(a)) and round cross sections, as depicted in FIG. 2(b), are possible.

The surface structure improvement associated with the melting of the gold surface of the substrate 10 is illustrated in FIG. 3. FIG. 3 shows, in (a), an AFM image of a gold surface that was melted in a circular sub-region through laser bombardment, and in FIG. 3(b), a height profile along the line B-B in FIG. 3(a). It can be clearly seen that, due to the melting, the roughness of the surface is reduced and the homogeneity of the irradiated area is increased. This facilitates the attachment of probe molecules to the wetting areas 16, described below.

Returning to FIG. 1, FIG. 1(d) shows the wetting of the patterned substrates with nucleic acid oligomers by means of a wetting apparatus 22 in a pseudo-contact printing method.

The synthesis of the oligonucleotides occurs in an automatic oligonucleotide synthesizer (Expedite 8909; ABI 384 DNA/RNA Synthesizer) according to the synthesis protocols recommended by the manufacturer for a 1.0 μmol synthesis. In the syntheses with the 1-O-dimethoxytrityl-propyl-disulfide-CPG support (Glen Research 20-2933), the oxidation steps are carried out with a 0.02 molar iodine solution to avoid oxidative cleavage of the disulfide bridge. Modifications at the 5′-position of the oligonucleotides occur with a coupling step extended to 5 min. The amino modifier C2 dT (Glen Research 10-1037) is built into the sequences with the respective standard protocol. The coupling efficiencies are determined online during the synthesis, photometrically or conductometrically, via the DMT cation concentration.

The oligonucleotides are deprotected with concentrated ammonia (30%) at 37° C. for 16 h. The purification of the oligonucleotides occurs by means of RP-HPL chromatography according to standard protocols (mobile solvent: 0.1 molar triethylammonium acetate buffer, acetonitrile), and the characterization by means of MALDI-TOF MS. The amine-modified oligonucleotides are coupled to the corresponding activated fluorophores (e.g. fluorescein isothiocyanate) in accordance with the conditions known to the man skilled in the art. The coupling can occur either prior to or after the attachment of the oligonucleotides to the surface.

To the patterned substrate 10 is applied a doubly modified 20-bp single-strand oligonucleotide having the sequence 5′-AGC GGA TAA CAC AGT CAC CT-3′ (modification one: the phosphate group of the 3′-end is esterified with (HO—(CH₂)₂—S)₂ to P—O—(CH₂)₂—S—S—(CH₂)₂—OH, modification two: to the 5′-end is built in the flourescein modifier fluorescein phosphoramidite (Proligo Biochemie GmbH) according to the corresponding standard protocol) as a 5×10⁻⁵ molar solution in buffer (phosphate buffer, 0.5 molar in water, pH 7) with the addition of approx. 10⁻⁵ to 10⁻¹ molar propanethiol (or other thiols or disulfides of suitable chain length) with the aid of a spotter (Cartesian) (FIG. 1(d)) and incubated for 2 min-24 h. During this reaction time, the disulfide spacer P—O—(CH₂)₂—S—S—(CH₂)₂—OH of the oligonucleotide is homolytically cleaved. Here, the spacer forms a covalent Au—S bond with Au atoms of the surface, thus causing a 1:1 coadsorption of the ss-oligonucleotide and the cleaved 2-hydroxy-mercaptoethanol. The free propanethiol that is also present in the incubation solution is likewise coadsorbed by forming an Au—S bond (incubation step). Instead of the single-strand oligonucleotide, this single-strand can also be hybridized with its complementary strand.

For the loading with the spotter from Cartesian Technologies (MicroSys PA), split-pin needles 22 (Arraylt Chipmaker pins from TeleChem) are used that have a loading volume 24 of 0.2 to 0.6 μL and that release volumes 26 of about 1 nL per wetting process. A side view of the needle 22 in the wetting process and a wetted wetting area 16 are depicted in FIG. 1(e).

The contact area 28 of the needles 22 has a diameter of about 130 μm and is thus considerably larger than the substrate wetting areas 16 exposed by laser ablation. The positioning of the needle above the substrate occurs with a precision of 10 μm at a humidity of about 70-80%. The droplet 26 is released upon contact of the tip with the protective layer 14, and no direct contact of the needle 22 with the surface 12 to be wetted of the substrate 10 occurs. This situation is shown in the left partial image of FIG. 1(e). After wetting has occurred, a fluid droplet 30 is applied in a controlled manner to the wetting location 16 of the substrate (right partial image of FIG. 1(e)).

As an exemplary embodiment, a fluorescence intensity measurement on the Au-ss-oligo-fluorescein system will now be described. For this, as described above, wetting areas 16 are functionalized with nucleic acid oligomers on a patterned substrate 10. To do this, a modified oligonucleotide having the sequence 5′-fluorescein-AGC GGA TAA CAC AGT CAC CT-3′ [C₃—S—S—C₃—OH] is immobilized on gold (50 μmol oligonucleotide in phosphate buffer (K₂HPO₄/KH₂PO₄ 500 mmolar, pH 7), reloading with propanethiol 1 mM in water), and in the form Au—S(CH₂)₂-ss-oligo-fluorescein, the fluorescence intensity of the surface is determined with a fluorescence scanner from LaVision Biotech. To measure the fluorescence in the presence of liquid media, 150 μl of the medium is put on the gold surface and thereafter covered with a cover glass. Alternatively, HybriWells or an imaging chamber can also be used.

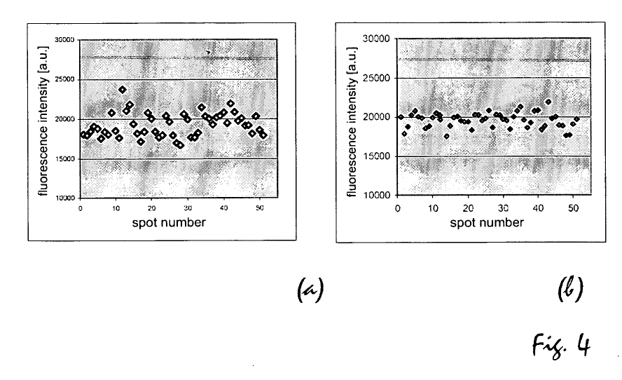

FIG. 4 shows the fluctuations in the fluorescence intensity of multiple identical measuring spots. The sequential number of the measuring spots is plotted on the abscissa, and the fluorescence intensity, measured in any units, on the ordinate. For the values in FIG. 4(a), the nucleic acid oligomers are spotted in a traditional manner, and for the values in FIG. 4(b), the wetting occurred by the above-described pseudo-contact printing method of the present invention. It can be clearly seen that, compared with the art, the fluctuations in the fluorescence intensities from measuring spot to measuring spot are significantly reduced by the actions according to the present invention.

In a further embodiment, a solder resist is used as the protective layer and to create wetting areas said solder resist being patterned with supplies for liquid analytes. With the aid of laser ablation of solder resist protective layers, in addition to the individual wetting areas, supply channels for fluids can be scribed in thick solder resist layers (for example 100-150 μm).

Here, in a first patterning step, various kinds of channels are cut into the paint through a first mask, the depth of these channels being able to be set by the number of pulses. A channel depth of about 80-120 μm is achieved with about 540-900 laser pulses (20 ns) with a fluence of 600-1200 mJ/cm². Then, in a second patterning step, through a second mask, the remaining paint is removed in individual regions within the channels of the first patterning step by additional laser exposure with about 90-150 pulses (20 ns), and the substrate thus exposed and melted. These exposed substrate locations are now wetted with nucleic acid oligomers as described above.

On a substrate described above, multiple wetting areas, each linked via one of the channels in the solder resist, can be specifically brought into contact with an analyte, such as fluids that potentially contain complementary nucleic acid oligomers, and thus the analyte fluid required for an analysis is considerably reduced.

A channel pattern that, e.g., per channel links only a portion of the exposed substrate locations is an arrangement of n linear channels, all of which include m wetting areas of a column of a uniform spot matrix having the dimension n×m, wherein expediently 10≦n and m≦1000. Another channel pattern that links all exposed substrate locations with one another is a single channel that links, in a meander form, all exposed substrate locations of the uniform wetting area matrix having the dimension n×m, wherein expediently 10≦n and m≦1000.

1. A method for wetting a substrate with a fluid, comprising:
a) providing a substrate having a surface to be wetted;
b) providing a wetting fluid;
c) applying to the substrate a protective layer that separates the surface to be wetted from the surroundings;
d) patterning the protective layer to expose predetermined wetting areas on the substrate surface to be wetted; and
e) applying the wetting fluid to the exposed wetting areas by means of a wetting apparatus without direct contact between the wetting apparatus and the substrate surface to be wetted;
wherein the wetting apparatus exhibits a fluid-dispensing end surface whose lateral dimension in at least one direction in space is greater than the lateral dimension of the wetting area in the at least one direction in space.

2. The method according to claim 1, wherein the substrate comprises plastic, metal, semiconductor, glass, composite material or porous material.

3. The method according to claim 1 wherein the surface to be wetted comprises a silicon layer, a platinum layer, a gold layer, an oxidic surface or a glass.

4. The method according to claim 1, wherein the substrate comprises a macroscopic solid disk, a micro-particle or nanoparticle.

5. The method according to claim 1, wherein the wetting fluid comprises a purely liquid substance, a solution of organic and/or inorganic substances, an emulsion, a suspension or a colloidal solution.

6. The method according to claim 1, wherein the protective layer is physisorbed or chemisorbed on the substrate surface to be wetted, or bound to the substrate surface to be wetted covalently, coordinatively or by complex formation.

7. The method according to claim 1, wherein the protective layer comprises a positive or negative photoresist.

8. The method according to claim 1 wherein the protective layer comprises a solder resist, said solder resist applied by screen printing, curtain coating or a spraying method.

9. The method according to claims 1 wherein the protective layer is an organic polymer comprising cellulose, dextran or collagen.

10. The method according to claim 1 wherein the protective layer is a self-assembled monolayer comprising organic molecules.

11. The method according to claim 10 wherein the self-assembled monolayer is applied by organic molecules dissolved in a solution comprising an aqueous or organic solvent and bringing the solution into contact with the substrate.

12. The method according to claim 10 wherein the substrate is a solid whose surface to be wetted is formed by a gold layer, and the protective layer is a self-assembled monolayer comprising thiols, especially having the general structure HS-spacer-R or [S-spacer-R]₂, wherein R is any headgroup and the spacer has a chain length of 1-20, especially 1-14.

13. (canceled)

14. (canceled)

15. (canceled)

16. (canceled)

17. (canceled)

18. The method according claim 1 wherein the protective layer is patterned by means of laser ablation, by irradiation of sub-regions of the protective layer with laser radiation of a predetermined wavelength.

19. (canceled)

20. (canceled)

21. The method according to claim 1 wherein the protective layer is removed without residue in the region of the wetting areas.

22. (canceled)

23. (canceled)

24. (canceled)

25. The method according claim 1 further comprising the step of introducing supply channels into the protective layer to facilitate the supply of an analyte fluid to the exposed wetting areas.

26. (canceled)

27. (canceled)

28. (canceled)

29. (canceled)

30. (canceled)

31. The method according to claim 1 wherein the end surface of the wetting apparatus exhibits in both directions in space a larger lateral dimension than the wetting areas.

32. The method according to claim 1 wherein the end surface of the wetting apparatus is, at one wetting area, brought into contact with the protective layer adjoining said wetting area.

33. The method according to claim 1 wherein the end surface of the wetting apparatus is, across the entire wetting area and from above, brought into contact with the surface of the protective layer adjoining the wetting area.

34. The method according to claim 1 wherein the end surface of the wetting apparatus is positionable laterally above a patterned protective layer with a precision (Δx, Δy), and the wetting areas are created with a characteristic lateral dimension (xₛₚₒₜ, yₛₚₒₜ) that is smaller than the lateral dimension (xₜᵢₚ, yₜᵢₚ) of the end surface of the wetting apparatus by at least the positioning precision (Δx, Δy).

35. The method according to claim 1 wherein the wetting fluid comprises a modified nucleic acid oligomers in aqueous solution, said nucleic acid oligomers being modified with one or more reactive groups, and at least one reactive group being designed for a direct reaction with the substrate surface to be wetted.

36. (canceled)

37. (canceled)

38. (canceled)

39. (canceled)

40. (canceled)
